(19) United States
(12) Patent Application Publication
(10) Pub. No.: US 2026/0104566 A1
(43) Pub. Date: Apr. 16, 2026

(54) CONTROL LINE CONDITIONING FOR FIBER OPTICS

(71) Applicant: Precise Downhole Services Ltd., Nisku (CA)

(72) Inventors: Michael Melnychuk, Nisku (CA); Daniel Keough, Nisku (CA)

(21) Appl. No.: 19/359,428

(22) Filed: Oct. 15, 2025

Related U.S. Application Data
(60) Provisional application No. 63/707,652, filed on Oct. 15, 2024.

(51) Int. Cl. G02B 6/44; G01D 21/02

(52) U.S. Cl. CPC G02B 6/4488; G01D 21/02

(57) ABSTRACT

Corrosion resistant tubing for use as a control line or capillary tubing in a downhole fiber optic installation which has been treated by heating the tubing at or above about 315° C. for a sufficient time to remove at least a substantial portion of hydrogen in the tubing.

### FIELD OF THE INVENTION

The present invention generally relates to a method and system for conditioning control lines for installation in a fiber optic distributed sensing system, such as distributed temperature sensing (DTS), distributed acoustic sensing (DAS) and distributed strain sensing (DSS) systems, for example.

### BACKGROUND

Control line tubing is conventionally manufactured by rolling and welding stainless steel along a longitudinal seam. This process inherently creates and traps minute amounts of hydrogen in the tubing. This hydrogen can cause attenuation in fiber optic systems over time, resulting in temperature measurement drift. It has been well studied and is well known that hydrogen can affect the fiber optic signal and data quality, but even minute amounts of hydrogen can cause a temperature shift and compromise long term data quality. Most optical fibers intended to be used in a harsh environment are carbon coated to block hydrogen ingress, but this coating becomes less and less effective at temperatures above 150° C. At temperature approaching 200° C., the coating is almost completely ineffective and is permeable to hydrogen.

Control line tubing is often heat treated to remove the fluid or solvent used to deploy the optical fiber, for example, heat treatment at about 100° C. flashes off the isopropyl alcohol that is typically used. Higher temperatures, up to about 300° C. can remove heavier hydrocarbons.

There remains a need in the art for methods of reducing hydrogen attenuation in a fiber optic system.

### SUMMARY OF THE INVENTION

In one aspect, disclosed is a method of conditioning corrosion resistant tubing for use as a control line or capillary tubing in a downhole fiber optic installation, comprising the step of heating the tubing at or above about 315° C., for a sufficient time to remove at least a substantial portion of hydrogen in the tubing. The temperature is preferably between about 375° to about 450° C., and more preferably between about 400° C. to about 425° C.

In some embodiments, the tubing comprises stainless steel, such as SAE standard grades 316, 2205 or 825.

In some embodiments, the method further comprises the step of flowing a gas through and/or around the tubing during the heating step, to carry away hydrogen gas from the tubing. The gas may be an inert gas, and may or may not include oxygen.

In another aspect, disclosed is a control line or capillary tubing which comprises a corrosion resistant metal substantially devoid of hydrogen. The metal may comprise a stainless steel. In some embodiments, the tubing may further comprise a chromium oxide surface barrier, which is present on either or both an interior surface or an external surface of the tubing.

In another aspect, disclosed is a distributed sensor system comprising the tubing described herein, which may be a distributed temperature sensing (DTS), distributed acoustic sensing (DAS) or a distributed strain sensing (DSS) system.

### BRIEF DESCRIPTION OF THE FIGURES

FIG. 1 (prior art) is a graph of hydrogen diffusivity in different stainless steels at different temperatures.

### DETAILED DESCRIPTION

The present invention now will be described more fully hereinafter with reference to the accompanying drawings, in which some, but not all embodiments of the invention are exemplified. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

In one aspect, described is a method of conditioning stainless-steel tubing by heating the tubing to a temperature above about 315° C. The primary effect of this treatment is to remove hydrogen from the metal tubing.

In preferred embodiments, the treatment temperature is between about 375° to about 450° C. Higher temperatures will expedite the process, however at approximately 430° C. and above, chromium carbide can begin to form on the inside the tubing, which looks like a black soot. While it is believed that this is not detrimental, it is preferred to remain in the range between about 400° to about 425° C. In preferred embodiments, the total treatment time, including preheating is between about 6 hours to about 10 hours at 400° C.

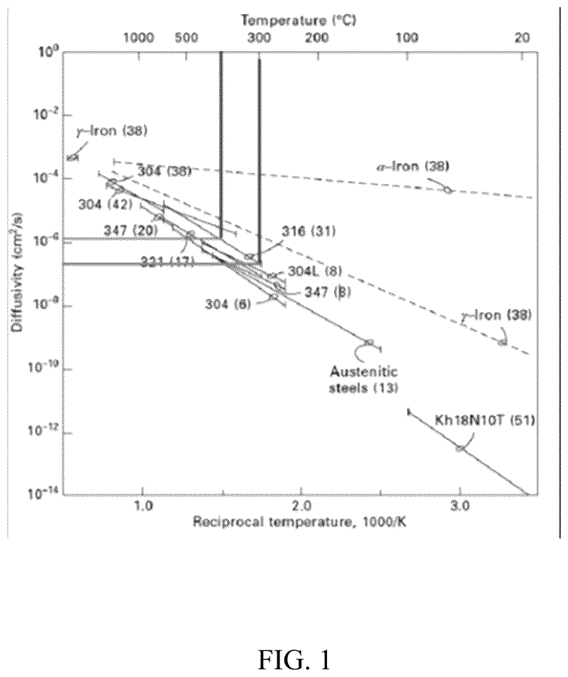

Hydrogen diffusion through steel is governed by Fick's law of diffusion, where:

$$T = {x}^{2} / 2 D$$

Where T is diffusion time, x is the thickness of material and D is the diffusion coefficient. The diffusion coefficient of hydrogen in a metal is governed by the type of metal and temperature, and may be empirically determined as is known to those skilled in the art, as may be seen in FIG. 1.

Thus, at a temperature of 400° C., the diffusion coefficient of hydrogen in SAE 316 steel is about 10⁻⁶ cm²/s. Thus, hydrogen will substantially diffuse through SAE 316 steel tubing which is 1.25 mm thick at 400° C. in about 4.3 hours.

In preferred embodiments, the heat treatment is combined with a gas purge which carries away hydrogen which is driven off by the heat treatment. For example, an inert gas such as nitrogen or argon may be flowed through and/or around the tubing during heat treatment, to carry away any the hydrogen diffusing out of the metal.

Heat treatment may also result in surface oxidation of the tubing if oxygen is present, and chromium oxide may form on steels with significant chromium content, such as 316, 825 or 2205 duplex grade stainless steel. Chromium oxide is a barrier to hydrogen diffusion and also increases the corrosion resistance of the tubing. Thus, a surface layer of chromium oxide may prevent any residual hydrogen that remains in the steel from diffusing out of the tubing when in use and affecting temperature measurements. Since this chromium oxide layer inhibits the migration of hydrogen, this can also allow the use of thinner wall thicknesses, for example thinner than 1.25 mm (0.049 inches), such as 0.028 inches or 0.015 inches.

In some embodiments, a gas purge which uses air, or combines an inert gas such as nitrogen with a small amount of oxygen may be passed through and around the tubing during heat treatment. This will allow an oxide barrier layer to form on both the outside and the inside of the tubing, which can result in any residual hydrogen being sealed within the steel. As the hydrogen level remains stable over time, temperature measurements will not drift significantly due to hydrogen level fluctuation.

In an alternative embodiment, a gas purge which uses air, or combines an inert gas such as nitrogen with a small amount of oxygen may be passed inside the tubing during heat treatment. This creates an oxide barrier to form on the inside of the tubing wall while removing any hydrogen which diffuses outwards of the tubing wall.

In different aspects, disclosed are embodiments which combines any step, feature or element described herein, or omits any preferred or optional step, feature or element, in order to treat or condition control line tubing.

### Interpretation.

The forgoing description supplies specific details in order to provide a thorough understanding. Nevertheless, the skilled artisan would understand that the apparatuses, systems, and associated methods of using the apparatuses and systems can be implemented and used without employing these specific details. Indeed, the apparatuses, systems, and associated methods can be placed into practice by modifying the illustrated apparatus and associated methods and can be used in conjunction with any other apparatus and techniques conventionally used in the industry.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular claim, feature, structure, or characteristic, but not every embodiment necessarily includes that claim, feature, structure, or characteristic. Moreover, such phrases may, but do not necessarily, refer to the same embodiment referred to in other portions of the specification. Further, when a particular claim, feature, structure, or characteristic is described in connection with an embodiment, it is within the knowledge of one skilled in the art to affect or connect such module, claim, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method of conditioning corrosion resistant tubing for use as a control line or capillary tubing in a downhole fiber optic installation, comprising the step of heating the tubing at or above about 315° C., for a sufficient time to remove at least a substantial portion of hydrogen in the tubing.

2. The method of claim 1, wherein the temperature is between about 375° to about 450° C.

3. The method of claim 2 wherein the temperature is between about 400° C. to about 425° C.

4. The method of claim 1 wherein the heat treatment lasts for at least about 4 hours.

5. The method of claim 1, wherein the tubing comprises stainless steel.

6. The method of claim 5, wherein the tubing comprises SAE standard grades 316, 2205 or 825.

7. The method of claim 1, further comprising the step of flowing a gas through and/or around the tubing during the heating step, to carry away hydrogen gas from the tubing.

8. The method of claim 7 wherein the gas comprises nitrogen, in the absence of oxygen or with oxygen present.

9. A control line or capillary tubing comprising a corrosion resistant metal substantially devoid of hydrogen.

10. The control line or capillary tubing of claim 9, comprising a stainless steel.

11. The control line or capillary tubing of claim 10, comprising a chromium oxide surface barrier.

12. The control line or capillary tubing of claim 11 wherein the chromium oxide surface barrier is present on one of or both of an interior surface and an external surface of the tubing.

13. A distributed sensor system comprising the tubing of claim 10.

14. The distributed sensor system of claim 13 which is a distributed temperature sensing (DTS), distributed acoustic sensing (DAS) or a distributed strain sensing (DSS) system.
